(19) United States
(12) Patent Application Publication
(10) Pub. No.: US 2012/0078644 A1
(43) Pub. Date: Mar. 29, 2012

(54) DONATION IMPACT CALCULATOR

(76) Inventors: Arlene McCrehan, (US); Adam Stiska, (US)

(21) Appl. No.: 12/890,384

(22) Filed: Sep. 24, 2010

(51) Int. Cl. G06Q 99/00

(52) U.S. Cl. 705/1.1

(57) ABSTRACT

The invention provides a method for conveying information to a donor about a prospective donation, the method comprising: a) providing a donor with a list containing a plurality of types of non-monetary contributions; b) prompting the donor to enter at least one of the types of non-monetary contributions and to set a number of each at a user interface; c) determining the benefit that may be derived from each of the entered types of non-monetary contributions and number of each; and d) informing the donor of such benefit.

### REFERENCE TO RELATED APPLICATION

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other copyright rights.

### BACKGROUND OF THE INVENTION

1. Field of the Invention

This invention describes an online, internet-based process for encouraging donors to make non-monetary charitable contributions by providing information on the ultimate benefit derived from those donations.

2. Description of Related Art

The internet has greatly impacted the world of fundraising and charitable giving. In many ways, the internet benefits charities by extending their reach beyond local communities, to donors worldwide. Conversely, donors benefit by having access to a greater number of charities from which to choose and by having a greater ability to gather information about a particular charity.

This improved access has also led to a heightened level of expectations by donors for information about their donations. Many charities now seek to communicate to the prospective donor the benefit that may be achieved through the donation, and many donors expect specific information about what project their donation has contributed to, or how the money will be dispersed.

One example of internet-based advertisement for charities appears in U.S. Patent Publication No. 2010/0030659, submitted by Epstein and published on Feb. 4, 2010. This application provides an electronic picture, placed on a webpage that is divided into multiple sections, each having a corresponding price. The donor “purchases” a particular section of the picture and is then allowed to associate an audio, moving picture file or the like with the section of the picture that is activated when a subsequent visitor to the website passes a pointer over the purchased portion and clicks thereon. This approach rewards the donor the ability to provide content or a message to others, in exchange for the donation.

U.S. Patent Publication No. 2008/0065513, submitted by McHale et al. and published on Mar. 13, 2008, discloses a method allowing a non-profit organization to build catalogs of consignment items for inclusion in an auction or raffle. In one aspect, the method allows a donor to contribute all or a portion of the cost of a particular consignment item to the charity. Although this system imparts to the donor some knowledge and control over what a monetary donation may be used for, this system does not the donor of the benefit derived by the charity from the donation.

U.S. Patent Publication No. 2007/0106575, submitted by Barr et al. and published on May 10, 2007, discloses a system for managing or reporting the status or needs of one or more charitable projects. One of the purported benefits of the system is that it allows for specific money, donated for a specific activity, to be tracked to results associated with that activity.

Because of their business models, however, certain charities will have even more specific communication requirements. Many charities that deal in used goods have a business model where donations of used materials are solicited for specific purposes. Some models use proceeds made from selling the used materials to provide services to third parties, including job training to the unemployed or underemployed. Charities with such business models can find it difficult to communicate to their donors the real benefits of their donors' non-monetary contributions.

Thus, as is shown by the forgoing examples, none of the prior approaches have been able to meet the need for a quick, efficient and effective system that conveys to a potential donor a specific benefit that is likely to result from a particular non-monetary donation.

### SUMMARY OF THE INVENTION

The invention provides a method for conveying information to a donor about a prospective donation by providing a donor with a list containing a plurality of types of non-monetary contributions, prompting the donor to enter at least one of the types of non-monetary contributions and to set a number of each at a user interface, determining the benefit that may be derived from the types of non-monetary contributions and the number of each and informing the donor of the benefit.

Examples of non-monetary contributions include various types or categories of used goods, for example, articles of clothing, household furnishings, bedding, home sundries, toys, books, recorded media, home electronics, kitchen appliances, dishes, kitchen utensils and dining utensils.

In one preferred embodiment, the invention utilizes computer executable code, for example the use of an algorithm in determining benefits from the donated goods.

The invention preferably includes access for the donor via a computer accessible network.

In a further preferred aspect, the invention includes a computer database containing information about at least one class of non-monetary donations and the non-monetary benefits realized by an organization correlating to each class of non-monetary donations.

In a still further preferred aspect calculation for determining a benefit are accomplished by: i) assigning a value to the non-monetary contribution; ii) assigning a value to a benefit; and iii) comparing the value of the total non-monetary contribution to the value of the benefit to determine the benefit associated with the non-monetary contribution.

In a preferred aspect of the invention, the value of the non-monetary contributions will be based on the average of a plurality of known values.

In a different preferred embodiment of the invention, the benefit value that is derived by the charity is measured in the amount of time for training a third party. In a preferred such aspect, the parties undertaking training are under-employed or unemployed, and the training may be designed to help in obtaining employment, in maintaining employment, in financial planning and/or in life skills.

In one preferred embodiment, the third party is unemployed or underemployed.

The invention further provides a system for transmitting information relating to the non-monetary benefits of a donation, the system comprising: a) a user interface; b) a server configured to receive information entered at the user interface relating to at least one non-monetary donation; c) the server being in communication with a computer database containing information about at least one class of non-monetary donation and the non-monetary benefits realized by an organization correlating to the class of non-monetary donation; d) the server being capable of correlating the entered information the benefit realized by the organization; and e) a display at the user interface for portraying the benefit resulting from the donation.

The invention also provides a method for displaying information to a user about a donation, comprising: a) providing a server comprising a database of a plurality of categories of non-monetary contributions; b) providing a server containing a database of non-monetary benefits to the organization; c) providing an interface for a user to select at least one of the contribution categories and choose a number of items of the at least one selected category; d) accessing the contributions server and the benefits server and correlating the chosen number of selected categories with the benefits to the organization; and e) displaying the benefits to the user interface.

In an alternative embodiment, the method of the invention comprises: a) receiving a request for information about a donation from a user; b) accessing a database having a listing of categories of non-monetary donations; c) comparing the request from the user with the database listings and selecting a matching category of non-monetary donations; d) determining the benefit that may be derived from the number and types of the non-monetary donations; and e) displaying the benefit to the user.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 depicts a flow chart demonstrating the steps in the method for one aspect of the invention.

FIG. 2 provides a website snapshot showing the user interface.

### DETAILED DESCRIPTION OF THE INVENTION

Under the systems and methods of the present invention, the value of a particular non-monetary donation is determined and displayed to the donor. Determinations are calculated based on known value data for similar non-monetary donations and compared against the known value of a benefit so as to allow the donor to be informed of the specific quantitative benefit that is likely to result from the donation.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

In this description, the term “donor” means a donor or potential donor of goods to a charitable organization, and may include individuals, groups, entities and agents thereof.

By “unemployed” or “underemployed” is meant persons who are not employed at the time at issue or whose compensation is below average given their community or circumstances or whose job-circumstance is otherwise undesirable.

The term “non-monetary” or “non-monetary contribution” is to be broadly construed and is only limited by the exclusion of currency and currency equivalents, such as credit cards, checks or similar promises to convey currency.

By “benefit” is meant any result anticipated by the donor to occur as the result of or in connection with the donation.

By “server” is meant any computer or computer-based or compatible machine that acts as a host, or otherwise in service of the needs of client machines, and can be local or remote, accessed in any number of formats, and includes a mainframe, minicomputer, or personal computer that operates in a time-sharing mode to provide for the needs of clients for applications such as computation, access, file storage, network administration, security, and other critical functions.

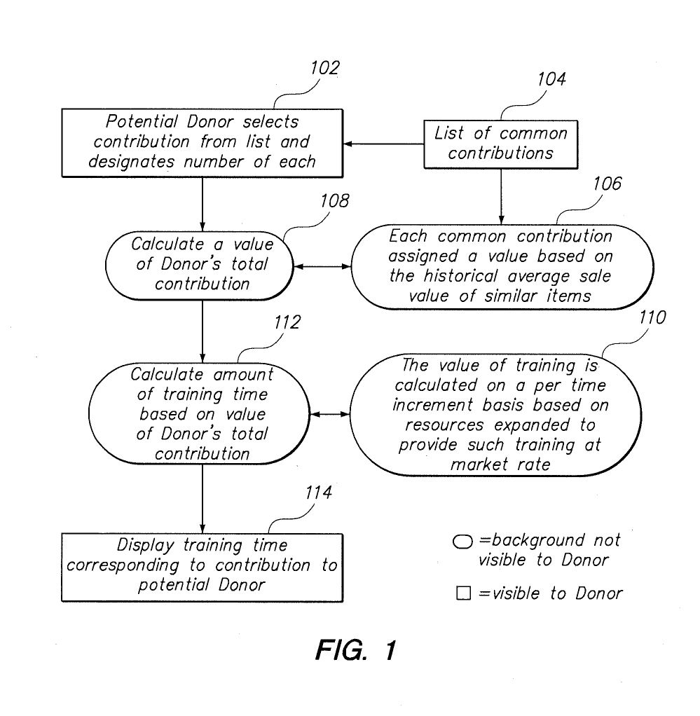

FIG. 1 depicts a first embodiment of the method of the invention, shown in flow chart format. Most typically, the method and system are largely conducted by computer programming located on a server, and is accessed via a publicly accessible webpage through the interne.

A user interface generally provides access for the donor. As depicted in FIG. 1, the steps that are shown in squares are steps that are displayed on the user access, such as a webpage, and which would be visible to the donor. Steps shown as ovals represent steps performed in the background, for instance on the remote server, and generally invisible to the donor.

Value or benefit determinations are typically accomplished through the use of computer programming, such as an algorithm, programming or through the consultation of data tables and the like.

Looking now more particularly at FIG. 1, at the user interface 102, the donor chooses one or more types of non-monetary contributions and designates the number of each such type the donor wishes to donate. To facilitate the donor's choice, a list of commonly donated items 104 may be displayed to the donor.

The server typically manages the steps seen in items 106, 108, 110 and 112. The server maintains a database, where each listed item is associated with a value 106. Such values may be derived from the historical average value of similar items as determined by previous sales of such items by the charity or similar charities. The list of values may be composed of an average of values from different geographical locations, so that the method may be used nationwide without modification for location.

Using the donor's choices 102 and the list of values 106, a value of the donor's total contribution is determined 108.

In addition to data on the value of potential non-monetary contributions, the method requires reference to data on the value of the benefit that will ultimately result from the donation 110. This data is not shown to the user, but is maintained by the server and utilized in the background in the calculating step 112. In the illustrated embodiment, the benefit constitutes job-related training provided to the unemployed or underemployed, and the value of the benefit is stored as a value-per-time increment of job-related training.

The value of such training may be based on known values, such as hours, that have been historically expended by the charity in providing such training, or may be based on some determination of the market rate for similar training. In a second calculating step 112, the value of the donor's total contribution 108 is compared to the incremental value of the job training time 110 to determine the amount of job training time 112 corresponding to the donor's total contribution. In a final step, the job training time corresponding to the potential donation is displayed to the donor 114.

Alternatively, the user may constitute a group of individuals wishing to track donations together, such as a family or other association having a common purpose. The group could also be a more formal collective, such as a non-profit organization, or other association, such as a partnership or corporation. In that event, the access may be adjusted to track all donations originating from the group, whether being submitted as individual or collective contributions of goods. Individuals associated with the group would be allowed to log on together and track the value of their joint or collective donations.

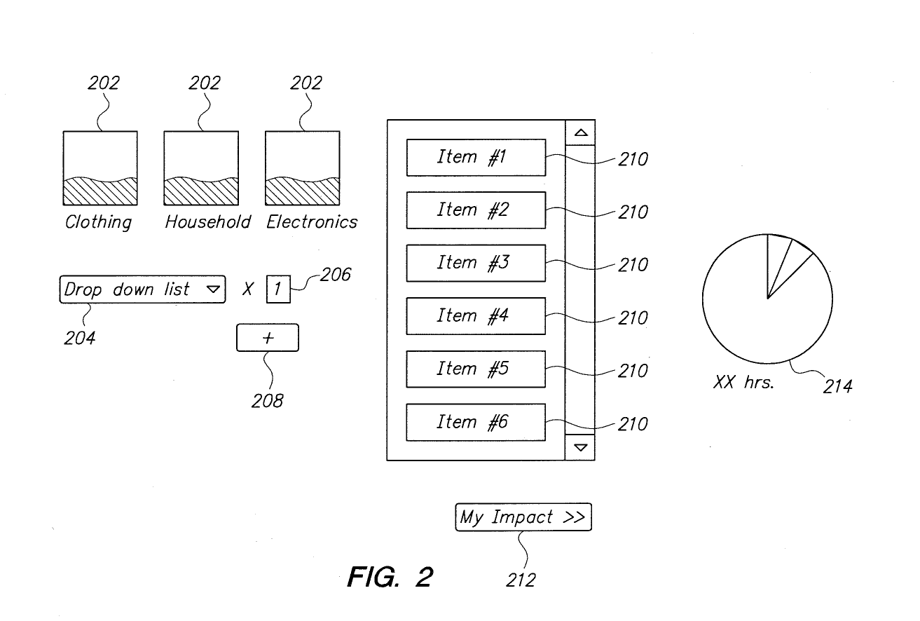

FIG. 2 depicts a screen for display on the user interface, for instance a web portal or webpage presented at the charities website. The donor may by prompted to select commonly donated items, which for simplicities sake can be organized into categories 202, i.e., clothing, household items and electronics. The donor can then choose a category by selecting or clicking on the category item 202, and then selecting an item presented from a corresponding drop-down list 204.

The donor may then choose the appropriate number of each of the selected items to be donated 206. Once the donor designates the item and number, the donor may add this to the total list of other items to be donated 210 and may repeat the process until the list is complete. Once the donor has described the entire potential donation, a final determination is made as per FIG. 1. The user interface will typically include a button 212 that initiates the benefit calculation. As seen in FIG. 2, the benefit is displayed as a corresponding amount of training time, in hours 214.

As will be apparent from the drawings, the invention provides a simple way to associate a potential donor's donation with a specific result showing the non-monetary benefit to the organization. This provides a sense of satisfaction to the donor, who may be encouraged to follow through with the donation, or return with additional goods from being able to know the tangible benefit to the organization from each donation.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A method for conveying information to a donor about a prospective donation, said method comprising:
a) providing a donor with a list containing a plurality of types of non-monetary contributions;
b) prompting said donor to enter at least one of said types of non-monetary contributions and to set a number of each at a user interface;
c) determining the benefit that may be derived from said types of non-monetary contributions and said number of each; and
d) informing the donor of said benefit.

2. The method of claim 1 wherein c) is accomplished utilizing computer executable code.

3. The method of claim 1 wherein c) further comprises the use of an algorithm.

4. The method of claim 1 further comprising a computer accessible network.

5. The method of claim 1 further comprising a computer database containing information about at least one class of non-monetary donation and the non-monetary benefits realized by an organization correlating to each class of non-monetary donation.

6. The method of claim 1, wherein c) comprises: i) assigning a value to the non-monetary contribution; ii) assigning a value to a benefit, and iii) comparing said value of the total non-monetary contribution to said value of the benefit to determine the benefit associated with said non-monetary contribution.

7. The method of claim 6 further comprising determining the value of said non-monetary contributions based upon the average of a plurality of known values.

8. The method of claim 6 wherein said non-monetary contributions comprise one or more categories of used goods.

9. The method of claim 8 wherein said used goods categories are selected from the group consisting of articles of clothing, household furnishings, bedding, home sundries, toys, books, recorded media, home electronics, kitchen appliances, dishes, kitchen utensils and dining utensils.

10. The method of claim 6 wherein said benefit value comprises an amount of time for training of a third party.

11. The method of claim 10 wherein said training is intended to assist said third party in obtaining or maintaining employment.

12. A system for transmitting information relating to the non-monetary benefits of a donation, said system comprising:
a) a user interface;
b) a server configured to receive information entered at said user interface relating to at least one non-monetary donation;
c) said server being in communication with a computer database containing information about at least one class of non-monetary donation and the non-monetary benefits realized by an organization correlating to said at least one class of non-monetary donation;
d) said server capable of correlating the entered information to the at least one benefit realized by the organization; and
e) a display at said user interface for portraying the benefit resulting from the donation.

13. The system of claim 12 wherein said user interface provides access via a web portal.

14. The system of claim 12 wherein said information in b) comprises the number and category of each non-monetary donation.

15. The method of claim 12 wherein said benefit in d) is provided to a third party.

16. The method of claim 15 wherein said benefit constitutes training.

17. The method of claim 16 wherein said training is a type of training selected from the group consisting of training for obtaining employment, training in maintaining employment, financial planning and life skills.

18. The method of claim 17 wherein said third party is unemployed or underemployed.

19. A method for displaying information to a user about a donation, said method comprising:
a) providing a server comprising a database of a plurality of categories of non-monetary contributions;
b) providing a server containing a database of non-monetary benefits to said organization;
c) providing an interface for a user to select at least one of said contribution categories and choose a number of items of said at least one selected category;
d) accessing said contributions server and said benefits server and correlating the chosen number of selected categories with said benefits to said organization; and
e) displaying said benefits to said user interface.

20. A method for conveying information to a user about a donation, said method comprising:
a) receiving a request for information about a donation from a user;
b) accessing a database having a listing of categories of non-monetary donations;
c) comparing the request from the user with the database listings and selecting a matching category of non-monetary donations;
d) determining the benefit that may be derived from the number and types of said non-monetary donations; and
e) displaying said benefit to said user.
